(19) United States
(12) Patent Application Publication
(10) Pub. No.: US 2011/0092331 A1
(43) Pub. Date: Apr. 21, 2011

(54) HARMONIC GEAR DEVICE

(75) Inventor: Per Olav Haughom, Tonstad (NO)

(73) Assignee: ANGLE WIND AS, Stavanger (NO)

(21) Appl. No.: 12/936,707

(22) PCT Filed: Apr. 17, 2009
(86) PCT No.: PCT/NO2009/000135

§ 371 Date: Dec. 22, 2010

(30) Foreign Application Priority Data
Apr. 17, 2008 (NO) 20081857

(51) Int. Cl. F16H 1/32

(52) U.S. Cl. 475/162

(57) ABSTRACT

A harmonic gear device (10) in which a spindle (28) and a gear rim (48) are rotatable relative to each other on a common centre axis (32), and in which a gearwheel (42), which is engaged with the gear rim (411), is rotatably connected to the spindle (28) around a first eccentric axis (36), and in which a balancing gearwheel (58), which is engaged with the gear rim (48) or a balancing gear rim, is rotatable around a second eccentric axis (40).

A harmonic gear is provided. More particularly, it is a harmonic gear, in which a spindle and a gear rim are positioned, rotatable relative to each other, on a common centre axis, and in which a gearwheel, which is engaged in the gear rim, is rotatably connected to the spindle around a first eccentric axis.

In what follows, the harmonic gear is explained with reference to a windmill. This does not in any way mean a restriction in the use of the harmonic gear provided.

As windmills are being built for increasingly greater effects, transmission elements transmitting torques between the wind turbine of the windmill and a power machine must be upsized correspondingly.

According to the prior art, a generator is often placed in an elevated nacelle at the wind turbine. The torque is transmitted from the wind turbine to the power machine, which may be constituted by an electric generator, via a gearbox. The gearbox is necessary for transforming up the relatively low rotational speed of the wind turbine to a rotational speed which is appropriate for the generator.

The total weight of the gearbox and generator is considerable. Especially for offshore windmills, such large masses positioned at a relatively high level above the seabed mean that the supporting structures will be extensive and costly.

It is known for torques to be transmitted from the wind turbine via transmission elements, for example an angular gear, to a generator located at ground level, see the German patent application 2932293, for example.

The transmission of the torque via a simple vertical shaft at principally the same rotational speed as the wind turbine is conditional on the supporting structure of the windmill having been dimensioned for receiving the full torque around its vertical axis. This condition has been remedied by using two concentric, counter-rotating shafts for the transmission of torque. Thereby the torque is substantially balanced, whereby the supporting structure is not subjected to said torques. U.S. Pat. No. 4,311,435 deals with a typical device for torque transmission of this kind.

The torque on the shafts is relatively great when there are used rotational speeds corresponding to the rotational speed of the wind turbine. Shafts and other transmission elements for the purpose may therefore be both large and expensive.

These unfortunate conditions may be remedied, at least partially, by fitting a harmonic gear between the wind turbine and the angular gear. A harmonic gear is both compact and light seen in relation to other relevant gears for the same purpose. However, because of their way of working, harmonic gears exhibit considerable imbalance in operation.

The invention has for its object to remedy or reduce at least one of the drawbacks of the prior art.

The object is achieved according to the invention through the features which are specified in the description below and in the claims that follow.

A harmonic gear is provided, in which a spindle and a gear rim are positioned, rotatable relative to each other, on a common centre axis, and in which a gearwheel, which is engaged with the gear rim, is rotatably connected to the spindle around a first eccentric axis. The harmonic gear is characterized by a balancing gearwheel, which is engaged with the gear rim or a balancing gear rim, being rotatable around a second eccentric axis.

An aspect of the harmonic gear is that the first eccentric axis and the second eccentric axis are mutually offset by 180 degrees around the centre axis.

Yet another aspect of the harmonic gear is that the gearwheel is rotatable about a first eccentric portion on the spindle.

A further aspect of the harmonic gear is that the balancing gearwheel is rotatable around a second eccentric portion of the spindle.

Yet another aspect of the harmonic gear is that the balancing gear rim forms part of the gear rim.

When used in a windmill, the wind turbine drives the gearwheel.

Yet another aspect of the harmonic gear is thus that the gearwheel is driven, the spindle forms an output shaft, the gear rim being stationary.

The transmission ratio, n, of the harmonic gear is given by the formula:

$$n = \frac{Zk}{Zh - Zk}$$

in which Zk is the number of teeth of the gear rim and Zh is the number of teeth of the gearwheel. The direction of rotation of the spindle is the opposite of the direction of rotation of the gearwheel.

The gearwheel and balancing gearwheel rotate at the same speed around the centre axis. By the first eccentric axis and the second eccentric axis being offset by 180 degrees around the centre axis, the gearwheel and the balancing gearwheel together may be in approximate balance.

The diameter of the second eccentric portion and the mass of the balancing gearwheel may be adjusted for the relevant conditions.

In the harmonic gear provided, the balancing gearwheel enables the gear to be balanced in a relatively simple and cost-effective way.

In what follows is described an example of a preferred embodiment which is visualized in the accompanying drawings, in which:

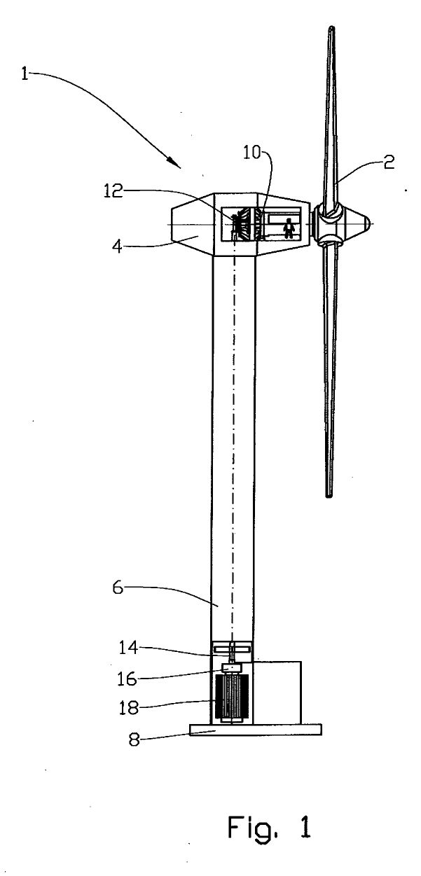

FIG. 1 shows a windmill which is provided with a harmonic gear and in which the generator is placed at ground level;

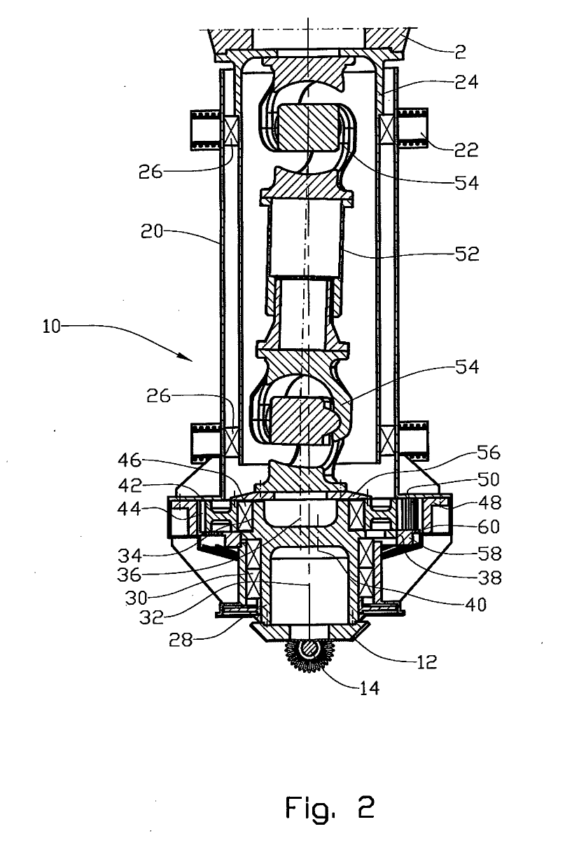

FIG. 2 shows partially schematically and on a larger scale a centric plan section of the harmonic gear;

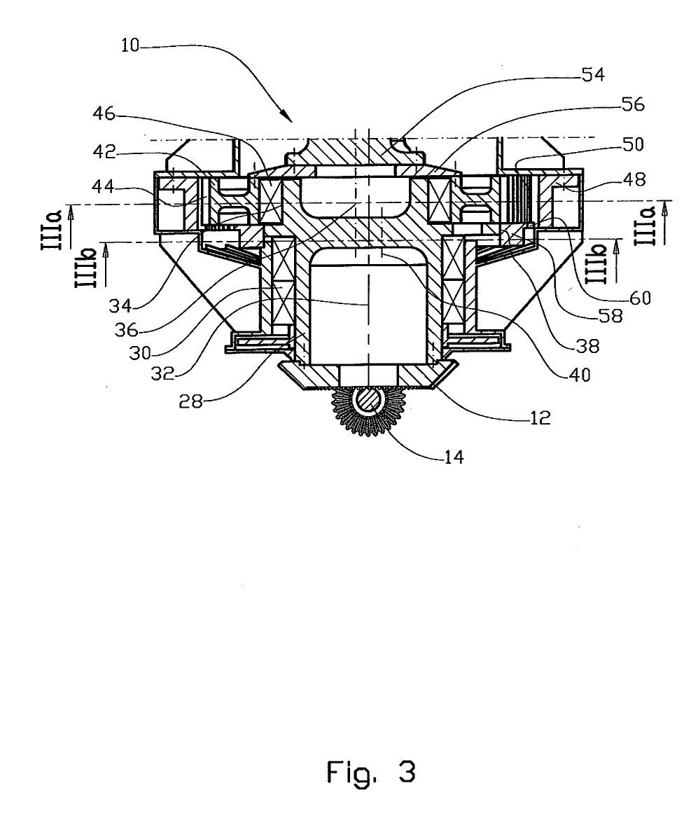

FIG. 3 shows a section of FIG. 2 on a larger scale;

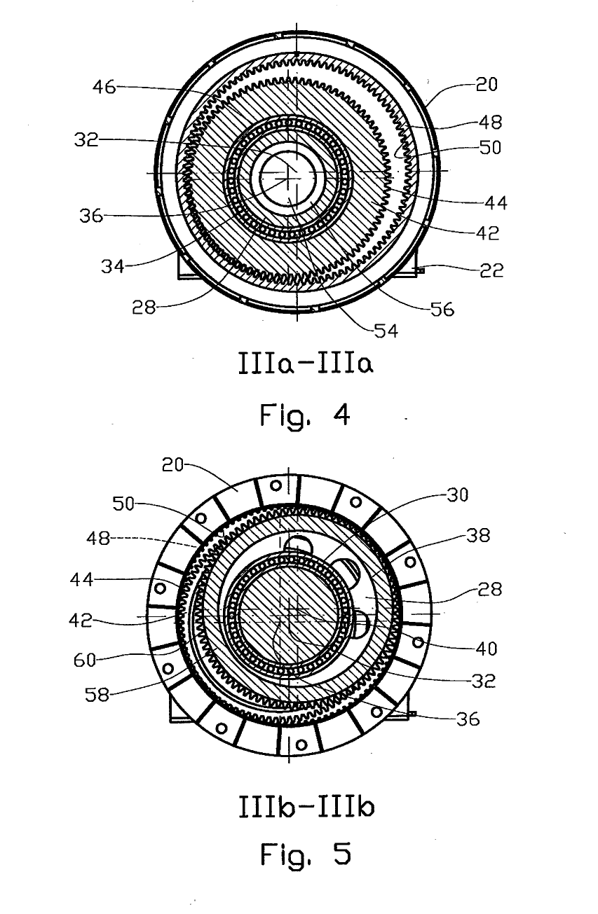

FIG. 4 shows a section IIIa-IIIa of FIG. 3; and

FIG. 5 shows a section IIIb-IIIb of FIG. 3.

In the drawings, the reference numeral 1 indicates a windmill comprising a wind turbine 2, an elevated nacelle 4, a supporting structure 6 and a foundation 8.

The wind turbine 2 is connected to a harmonic gear 10 positioned in the nacelle 4, the torque from the wind turbine 2 being transmitted via the harmonic gear 10, an angular gear 12, shafts 14, planetary gear 16 to a generator 18 positioned at the foundation 8.

The harmonic gear 10 includes a principally cylinder-shaped gear case 20 which is attached to the supporting structure 6 by means of mounting lugs 22, see FIG. 2.

The wind turbine 2 is connected to a sleeve-shaped, relatively elongated turbine shaft 24 projecting into the gear case 20, where the turbine shaft 24 is running in a first bearing 26.

A spindle 28 is supported, by means of a second bearing 30, in the gear case 20. The spindle 28 is at the opposite end portion of the gear case 20 relative to the wind turbine 2. The spindle 28 forms the output shaft of the harmonic gear 10 and is connected to the angular gear 12. In this preferred exemplary embodiment, the turbine shaft 24 and spindle 28 rotate around a common centre axis 32.

At its end portion opposite the angular gear 12, the spindle 28 is provided with a first cylindrical, eccentric portion 34 which has a first eccentric axis 36. Between the first eccentric portion 34 and the second bearing 30, the spindle is formed with a second cylindrical, eccentric portion 38 which has a second eccentric axis 40. The eccentric axes 36 and 40 are parallel to the centre axis 32 and are mutually offset by 180 degrees around the centre axis 32.

A gearwheel 42 with external teeth 44 is rotatable, by means of a third bearing 46, around the first eccentric portion 34.

The gearwheel 42 is engaged in a gear rim 48 having internal teeth 50. The gear rim 48 is connected to the gear case 20 and is concentric relative to the centre axis 32 and thereby the spindle 28. The teeth 50 of the gear rim 48 complementarily match the external teeth 44 of the gearwheel 42.

An intermediate shaft 52, which is provided with universal joints 54 at its end portions, connects the turbine shaft 24 via a drive plate 56 to the gearwheel 42. Thus, the gearwheel 42 rotates around the first eccentric axis 36 at a speed equal to that of the turbine shaft 24, the first eccentric axis 36 rotating around the centre axis 32.

A relatively large number of the external teeth 44 of the gearwheel 42 are engaged at the same time with the teeth 50 of the gear rim 48, see FIG. 4.

A balancing gearwheel 58 with external teeth 60 is freely rotatable around the second eccentric portion 38.

In this exemplary embodiment the numbers of teeth are: The gearwheel 42: Zh=90 and gear rim 48: Zk=100. The transmission is:

$$n = \frac{Zk}{Zh - Zk} = \frac{100}{90 - 100} = - \frac{10}{1}$$

When the gearwheel 42 has rotated a turn, the spindle 28 has rotated ten turns around the centre axis 32 but in the opposite direction. At the same time, both the gearwheel 42 and balancing gearwheel 58 have made, along with their respective eccentric axes 36, 40, ten revolutions around the centre axis 32.

By the first eccentric axis 36 of the gearwheel 42 and the second eccentric axis 40 of the balancing gearwheel 58 always being on radially opposite sides of the centre axis 32 and running at the same speed, eccentric forces generated will always counteract each other.

1. A harmonic gear device in which a spindle and a gear rim are rotatable relative to each other on a common centre axis, and in which a gearwheel, which is engaged in the gear rim, is rotatably connected to the spindle around a first eccentric axis, wherein a balancing gearwheel engaged with the gear rim or a balancing gear rim is rotatable around a second eccentric axis.

2. The device in accordance with claim 1, wherein the first eccentric axis and the second eccentric axis are mutually offset by 180 degrees around the centre axis.

3. The device in accordance with claim 1, wherein the gearwheel is rotatable around a first eccentric portion of the spindle.

4. The device in accordance with claim 1, wherein the balancing gearwheel is rotatable about a second eccentric portion of the spindle.

5. The device in accordance with claim 1, wherein the balancing gear rim forms part of the gear rim.

6. The device in accordance with claim 1, wherein the gearwheel is driven, the spindle forms an output shaft and the gear rim is stationary.
